(19) United States
(12) Patent Application Publication
(10) Pub. No.: US 2007/0174704 A1
(43) Pub. Date: Jul. 26, 2007

(54) Computer program automatic recovery activation control method and system

(75) Inventor: Wh Shih, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/392,189

(22) Filed: Mar. 28, 2006

(30) Foreign Application Priority Data
Dec. 1, 2005 (TW) 94142243

(51) Int. Cl. G06F 11/00

(52) U.S. Cl. 714/36

(57) ABSTRACT

A computer program automatic recovery activation control method and system is proposed, which is designed for use with a computer platform for providing the computer platform with an automatic recovery activation control function; and which is characterized by the capability of tracking the total number of failed startup procedures the computer platform has previously experienced, such that when the total failed startup count has reached a preset upper limit (such as 3), a recovery procedure is automatically at the next startup of the computer platform. This feature allows a corrupted startup control program to be automatically recovered entirely via program control without having to involve human intervention and occupy extra motherboard layout space, and also allows the recovery procedure to be activated in the event that the startup control program contains erroneous code but the checksum result is a match.

### BACKGROUND OF THE INVENTION

1. Field of the Invention

This invention relates to information technology (IT), and more particularly, to a computer program automatic recovery activation control method and system which is designed for use in conjunction with a computer platform having a memory module (such as a flash memory module) for storing a computer program, such as a BIOS (Basic Input/Output System) program or a server-based BMC (Baseboard Management Controller) program, for the purpose of responding to an event of the BIOS/BMC program code being corrupted and unable to boot the computer platform by automatically switching to a recovery mode for the purpose of activating a recovery procedure to recover the corrupted BIOS/BMC program code.

2. Description of Related Art

In applications of computers, when a user switches on the power of a computer platform, a startup procedure is carried out to boot the computer platform, whereby the operating system is loaded from a hard disk to the primary memory of the computer platform. As the operating system is successfully loaded, the user can then run application programs on the computer platform via the operating system3 s user interface. In practice, the startup control program is typically stored in an NVRAM (Non-Volatile Random-Access Memory) module, such as a flash memory module.

In practice, the computer code of the startup control program can be corrupted due to some mishaps in the computer platform, which would undesirably cause the computer platform to be unable to be booted. One solution to this problem is to provide a so-called “boot block” in the BIOS (Basic Input/Output System) memory module, which is a small segment of computer code that can be activated in response to an event of a failure to the BIOS startup control program that causes the computer platform to be unbootable. When activated, the boot block program is capable of performing a recovery procedure to recover the corrupted BIOS startup control program by loading a backup system image of the corrupted BIOS startup control program from a storage module (such as a hard disk) to the BIOS memory module.

In actual utilization, however, the above-mentioned boot block recovery method still has some drawbacks. For example, the newly-loaded BIOS code from the recovery procedure might contain erroneous code, but its checksum result for error detection is still a match that indicates that the loaded code is correct. The reason for this condition is that the checksum error detection method can be correct for most of the cases, but not one hundred percent correct. When data is erroneous but the checksum result is still a match, the boot block program is unable to detect such a condition.

Moreover, in actual operation, the execution of the boot block program requires the user to manually flip a special set of jumper switches on the motherboard for the purpose of setting the BIOS to recovery mode, whereby a recovery procedure can be performed. One drawback to this practice, however, is that it is quite laborious and timing-consuming. In addition, the use of the jumper switches for setting the recovery mode requires the collaboration of GPIO (General Purpose Input/Output) pins, which would undesirably make the motherboard more complex in circuit design and occupy more layout space.

### SUMMARY OF THE INVENTION

It is therefore an objective of this invention to provide a computer program automatic recovery activation control method and system which allows a corrupted startup control program in a computer platform to be automatically recovered entirely via program control to activate the recovery procedure without having to involve human intervention (i.e., manually flipping jumper switches and GPIO pins).

It is another objective of this invention to provide a computer program automatic recovery activation control method and system which allows the recovery procedure to be activated in the event that the startup control program contains erroneous code despite that the checksum result is a match.

It is still another objective of this invention to provide a computer program automatic recovery activation control method and system which can be implemented without having to occupy any layout space on the motherboard.

The computer program automatic recovery activation control method and system according to the invention is designed for use in conjunction with a computer platform having a memory module (such as a flash memory module) for storing a computer program, such as a BIOS (Basic Input/Output System) program or a server-based BMC (Baseboard Management Controller) program, for the purpose of responding to an event of the BIOS/BMC program code being corrupted and unable to boot the computer platform by automatically switching to a recovery mode for the purpose of activating a recovery procedure to recover the corrupted BIOS/BMC program code.

The computer program automatic recovery activation control method according to the invention comprises: (1) responding each.startup event on the computer platform by counting the total number of times that the computer platform has previously undergone a failed startup procedure; (2) comparing the total failed startup count against a preset upper limit; if smaller than the preset upper limit, issuing a startup program activation enable message; whereas if equal to the preset upper limit, issuing recovery procedure enable message; (3) responding to the startup program activation enable message by activating a startup control program to perform a startup procedure to boot the computer platform, and at the successful completion of the startup procedure, resetting the total failed startup count to its initial value; and (4) responding to the recovery procedure enable message by activating a recovery procedure to recover the computer program.

In architecture, the computer program automatic recovery activation control system is based on an object-oriented component model which comprises: (A) a startup event responding module, which is capable of responding to each startup event on the computer platform by issuing a startup count tracking enable message; (B) a startup count tracking module, which is capable of responding to the startup count tracking enable message from the startup event responding module by counting the total number of times that the computer platform has previously undergone a failed startup procedure; (C) a comparison module, which is capable of comparing the total failed startup count obtained by the startup count tracking module against a preset upper limit; if smaller than the preset upper limit, capable of issuing a startup program activation enable message; whereas if equal to the preset upper limit, capable of issuing recovery procedure enable message; (D) a startup control program activation module, which is capable of responding to the startup program activation enable message from the comparison module by activating a startup control program to perform a startup procedure to boot the computer platform, and which is further capable of issuing a startup count resetting enable message in response to a successful startup of the computer platform; (E) a startup count resetting module, which is capable of responding to the startup count resetting enable message from the startup control program activation module by resetting the total failed startup count to its initial value; and (F) a recovery procedure activation module, which is capable of responding to the recovery procedure enable message from the comparison module by activating a recovery procedure to recover the computer program.

The computer program automatic recovery activation control method and system according to the invention is characterized by the capability of tracking the total number of times the computer platform has failed to be booted after being powered on or reset, and the capability of automatically activate a recovery procedure in the subsequent startup of the computer platform after the total failed startup count has reached a preset upper limit (such as 3). This feature allows a corrupted startup control program to be automatically recovered entirely via program control without having to involve human intervention (i.e., manually flipping jumper switches and GPIO pins) and occupy extra motherboard layout space, and also allows the recovery procedure to be activated in the event that the startup control program contains erroneous code but the checksum result is a match.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the computer program automatic recovery activation control system according to the invention; and

FIG. 2 is a schematic diagram showing the object-oriented component model of the computer program automatic recovery activation control system of the invention.

### DETAILED DESCRIPTION OF PREFERRED EMBODIMENTS

The computer program automatic recovery activation control method and system according to the invention is disclosed in full details by way of preferred embodiments in the following with reference to the accompanying drawings.

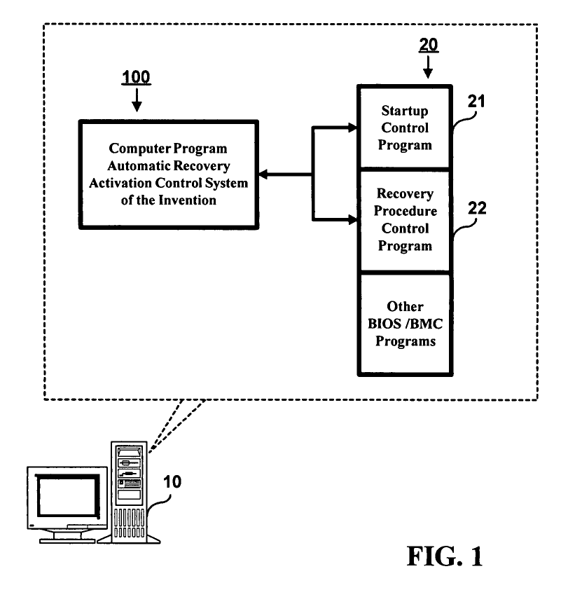

FIG. 1 is a schematic diagram showing the application of the computer program automatic recovery activation control system according to the invention (as the block indicated by the reference numeral 100). As shown, the computer program automatic recovery activation control system of the invention 100 is designed for use in conjunction with a computer platform 10, such as a desktop computer, a notebook computer, or a network server, that is equipped with a program resident memory unit 20, such as a flash memory unit, for storing a startup control program, such as a BIOS (Basic Input/Output System) program or a server-based BMC (Baseboard Management Controller) program. In actual operation, the computer program automatic recovery activation control system of the invention 100 is capable of responding to an event of the BIOS/BMC startup control program stored in the program resident memory unit 20 being corrupted and thus unable to boot the computer platform 10 by automatically switching the program resident memory unit 20 to a recovery mode for the purpose of performing a recovery procedure to recover the corrupted BIOS/BMC program code in the program resident memory unit 20, so as to allow the computer platform 10 to regain bootability. In actual application, the BIOS/BMC program code stored in the program resident memory unit 20 typically includes a startup control program 21 and a recovery procedure control program 22.

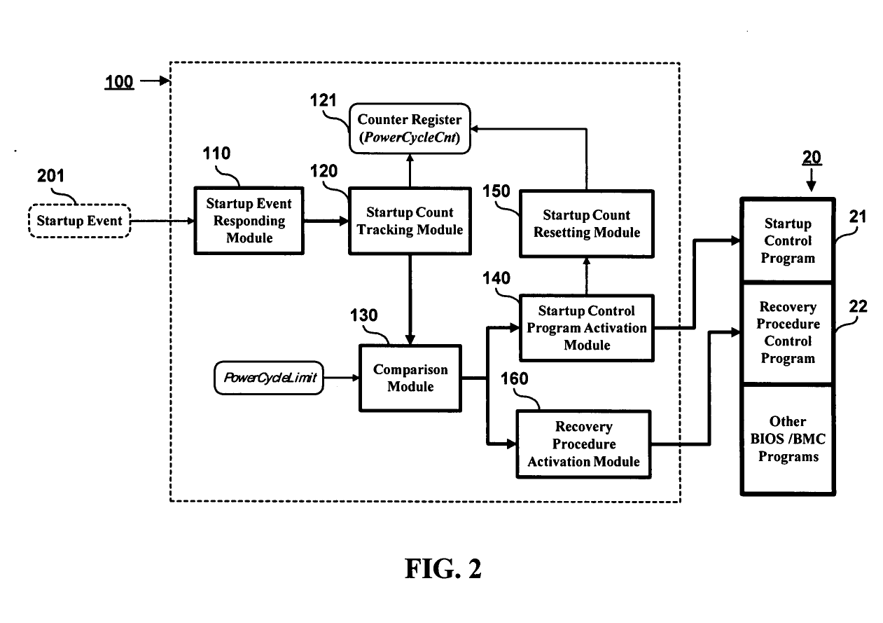

As shown in FIG. 2, in architecture, the computer program automatic recovery activation control system of the invention 100 is based on an object-oriented component model which comprises: (A) a startup event responding module 110; (B) a startup count tracking module 120; (C) a comparison module 130; (D) a startup control program activation module 140; (E) a startup count resetting module 150; and (F) a recovery procedure activation module 160. In practical implementation, the computer program automatic recovery activation control system of the invention 100 can be fully realized by computer code and integrated to the BIOS/BMC program code stored in the program resident memory unit 20.

Firstly, the respective attributes and behaviors of the constituent modules 110, 120, 130, 140, 150, 160 of the computer program automatic recovery activation control system of the invention 100 are described in details in the following

The startup event responding module 110 is designed to respond to each startup event 201 on the computer platform 10 (i.e., each time the computer platform 10 is powered on or reset by the user) by issuing a startup count tracking enable message to the startup count tracking module 120.

The startup count tracking module 120 includes a counter register 121 (which is for example denoted by PowerCycleCnt) for registering the total count of times that the computer platform 10 has previously undergone a failed startup procedure since the last time of successful startup. The PowerCycleCnt counter register 121 is initially set to zero (0). During actual operation, the startup count tracking module 120 is capable of responding to each startup count tracking enable message from the startup event responding module 110 by increasing the current value of the PowerCycleCnt counter register 121 by one to thereby keep track of the total number of failed startup procedures on the computer platform 10 since the last successful startup.

The comparison module 130 is designed to compare the total failed startup count PowerCycleCnt tracked by the startup count tracking module 120 against a preset upper limit PowerCycleLimit, which is for example preset at 4 (note that the value of this preset upper limit PowerCycleLimit is an arbitrary design choice, which can be instead 3, 5, or greater). If PowerCycleCnt is less than PowerCycleLimit, the comparison module 130 will responsively issue a startup program activation enable message to the startup control program activation module 140; and whereas if PowerCycleCnt is equal to PowerCycleLimit, the comparison module 130 will responsively issue a recovery procedure enable message to the recovery procedure activation module 160.

The startup control program activation module 140 is capable of responding to the startup program activation enable message from the comparison module 130 by activating the BIOS/BMC startup control program 21 stored in the program resident memory unit 20 to perform a startup procedure for booting the computer platform 10. If the startup procedure is successful, the startup control program activation module 140 will responsively issue a startup count resetting enable message to the startup count resetting module 150.

The startup count resetting module 150 is designed to respond to the startup count resetting enable message from the startup control program activation module 140 by resetting the total failed startup count PowerCycleCnt to its initial value, i.e., zero (0).

The recovery procedure activation module 160 is designed to respond to the recovery procedure enable message (this message indicates that the startup control program 21 is corrupted and unable to boot the computer platform 10) from the comparison module 130 by activating the recovery procedure control program 22 to perform a recovery procedure for the purpose of recovering the corrupted startup control program 21 in the program resident memory unit 20.

The following is a detailed description of two practical application examples of the computer program automatic recovery activation control system of the invention 100 during actual operation. In the first application example, it is assumed that the startup control program 21 is uncorrupted and capable of booting the computer platform 10 successfully; whereas in the second application example, it is assumed that the startup control program 21 is corrupted and thus unable to boot the computer platform 10.

Referring to FIG. 1 together with FIG. 2, in the first application example described above, when the user wants to utilize the computer platform 10, the user needs first to switch on the power of the computer platform 10, which initiates a startup event 201 on the computer platform 10. This startup event 201 will activate the computer program automatic recovery activation control system of the invention 100, whereby the startup event responding module 110 is first activated to respond to the startup event 201 by issuing a startup count tracking enable message to the startup count tracking module 120, causing the startup count tracking module 120 to respond by increasing the current value of the PowerCycleCnt counter register 121 by one (i.e., setting PowerCycleCnt to 1). Subsequently, the comparison module 130 is activated to compare the current value of PowerCycleCnt against a preset upper limit PowerCycleLimit of 4. At this stage, the comparison result is (PowerCycleCnt=1)<(PowerCycleLimit=4), and therefore the comparison module 130 will issue a startup program activation enable message to the startup control program activation module 140, whereby the startup control program activation module 140 is activated to perform a startup procedure to boot the computer platform 10.

If the above-mentioned startup procedure successfully boot the computer platform 10, then the startup control program activation module 140 will issue a startup count resetting enable message to the startup count resetting module 150, causing the startup count resetting module 150 to reset the total failed startup count PowerCycleCnt to its initial value, i.e., zero (0). On the contrary, if the startup control program 21, although uncorrupted, is notwithstanding unable to boot the computer platform 10 (the reason for this condition might be an error in transmission or outside electromagnetic interference that causes the code of the operating system to be erroneous when loaded), then the user can initiate a second startup event 201 to the computer platform 10, i.e., by resetting the computer platform 10. This action will cause the startup event responding module 110 to respond by issuing a startup count tracking enable message to the startup count tracking module 120, causing the startup count tracking module 120 to respond by increasing the current value of the PowerCycleCnt counter register 121 by one (i.e., setting PowerCycleCnt to 2). Subsequently, the comparison module 130 is activated to compare the current value of PowerCycleCnt against the preset upper limit PowerCycleLimit of 4. At this stage, the comparison result is (PowerCycleCnt=2)<(PowerCycleLimit=4), and therefore the comparison module 130 will likewise issue a startup program activation enable message to the startup control program activation module 140, whereby the startup control program activation module 140 is activated to perform a startup procedure to boot the computer platform 10. Normally, if the startup control program 21 is uncorrupted and the previous boot failure is due to error in transmission or outside electromagnetic interference, this problem can be often solved simply by resetting the computer platform 10 for several times (for example, 4 times). Therefore, if the startup control program 21 is uncorrupted, it would be usually able to successfully boot the computer platform 10 before the total failed startup count PowerCycleCnt reaches 4.

Referring again to FIG. 1 together with FIG. 2, in the second application example (i.e., the startup control program 21 is corrupted and unable to booth the computer platform 10), when the user wants to utilize the computer platform 10, the user needs first to initiate a startup event 201 to computer platform 10. This startup event 201 causes the responding module 110 to respond by issuing a startup count tracking enable message to the startup count tracking module 120, causing the startup count tracking module 120 to respond by increasing the current value of the PowerCycleCnt counter register 121 by one (i.e., setting PowerCycleCnt to 1). Subsequently, the comparison module 130 is activated to compare the current value of PowerCycleCnt against a preset upper limit PowerCycleLimit of 4. At this time, the comparison result is (PowerCycleCnt=1)<(PowerCycleLimit=4), and therefore the comparison module 130 will issue a startup program activation enable message to the startup control program activation module 140, whereby the startup control program activation module 140 is activated to perform a startup procedure to boot the computer platform 10. Since the startup control program 21 is corrupted, it will be a failure to boot the computer platform 10; and as a result, the startup count resetting module 150 will be inactivated such that the total failed startup count PowerCycleCnt will retain its current value (i.e., 1) without being reset to 0. After the first startup attempt fails, the user can reset the computer platform 10 to initiate a second startup event 201. This action will cause the startup event responding module 110 to respond by issuing a startup count tracking enable message to the startup count tracking module 120, causing the startup count tracking module 120 to respond by increasing the current value of the PowerCycleCnt counter register 121 by one (i.e., setting PowerCycleCnt to 2). Subsequently, the comparison module 130 is activated to compare the current value of PowerCycleCnt against the preset upper limit PowerCycleLimit of 4. At this stage, the comparison result is (PowerCycleCnt=2)<(PowerCycleLimit=4), and therefore the comparison module 130 will likewise issue a startup program activation enable message to the startup control program activation module 140. However, since the startup control program 21 is corrupted, it will be once again a failure to boot the computer platform 10. At the third startup attempt when the user resets the computer platform 10 to initiate a third startup event 201, it would be likewise unable to boot the computer platform 10. However, at the fourth startup attempt when the user once again resets the computer platform 10 to initiate a fourth startup event 201, it will cause the total failed startup count PowerCycleCnt to be set to 4. Under this condition, the comparison module 130 will obtain the comparison result (PowerCycleCnt=4)=(PowerCycleLimit=4), thus causing the comparison module 130 to issue a recovery procedure enable message to the recovery procedure activation module 160, causing the recovery procedure activation module 160 to activate the execution of the recovery procedure control program 22 in the program resident memory unit 20 to perform a recovery procedure for the purpose of recovering the corrupted startup control program 21 in the program resident memory unit 20.

In conclusion, the invention provides a computer program automatic recovery activation control method and system which is designed for use with a computer platform having a program resident memory unit storing a computer program for providing the computer program with an automatic recovery activation control function; and which is characterized by the capability of tracking the total number of times the computer platform has failed to be booted after being powered on or reset, and the capability of automatically activate a recovery procedure in the subsequent startup of the computer platform after the total failed startup count has reached a preset upper limit (such as 3). This feature allows a corrupted startup control program to be automatically recovered entirely via program control without having to involve human intervention (i.e., manually flippingjumper switches and GPIO pins) and occupy extra motherboard layout space, and also allows the recovery procedure to be activated in the event that the startup control program contains erroneous code but the checksum result is a match. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer program automatic recovery activation control method for use with a computer platform having a program resident memory unit storing a computer program for providing the computer program with an automatic recovery activation control function to activate a recovery procedure in the event of a failure to the computer program;
the computer program automatic recovery activation control method comprising:
responding each startup event on the computer platform by counting the total number of times that the computer platform has previously undergone a failed startup procedure;
comparing the total failed startup count against a preset upper limit; if smaller than the preset upper limit, issuing a startup program activation enable message; whereas if equal to the preset upper limit, issuing recovery procedure enable message;
responding to the startup program activation enable message by activating a startup control program to perform a startup procedure to boot the computer platform, and at the successful completion of the startup procedure, resetting the total failed startup count to its initial value; and
responding to the recovery procedure enable message by activating a recovery procedure to recover the computer program.

2. The computer program automatic recovery activation control method as recited in claim 1, wherein the program resident memory unit is a flash memory module.

3. The computer program automatic recovery activation control method as recited in claim 1, wherein the program resident memory unit is a BIOS (Basic Input/Output System) module.

4. The computer program automatic recovery activation control method as recited in claim 1, wherein

5. The computer program automatic recovery activation control method as recited in claim 1, which is realized as a computer program and integrated to the program resident memory unit.

6. A computer program automatic recovery activation control system for use with a computer platform having a program resident memory unit storing a computer program for providing the computer program with an automatic recovery activation control function to activate a recovery procedure in the event of a failure to the computer program;
the computer program automatic recovery activation control system comprising:
a startup event responding module, which is capable of responding to each startup event on the computer platform by issuing a startup count tracking enable message;
a startup count tracking module, which is capable of responding to the startup count tracking enable message from the startup event responding module by counting the total number of times that the computer platform has previously undergone a failed startup procedure;
a comparison module, which is capable of comparing the total failed startup count obtained by the startup count tracking module against a preset upper limit; if smaller than the preset upper limit, capable of issuing a startup program activation enable message; whereas if equal to the preset upper limit, capable of issuing recovery procedure enable message;
a startup control program activation module, which is capable of responding to the startup program activation enable message from the comparison module by activating a startup control program to perform a startup procedure to boot the computer platform, and which is further capable of issuing a startup count resetting enable message in response to a successful startup of the computer platform;
a startup count resetting module, which is capable of responding to the startup count resetting enable message from the startup control program activation module by resetting the total failed startup count to its initial value; and
a recovery procedure activation module, which is capable of responding to the recovery procedure enable message from the comparison module by activating a recovery procedure to recover the computer program.

7. The computer program automatic recovery activation control system as recited in claim 6, wherein the program resident memory unit is a flash memory module.

8. The computer program automatic recovery activation control system as recited in claim 6, wherein the program resident memory unit is a BIOS (Basic Input/Output System) module.

9. The computer program automatic recovery activation control system as recited in claim 6, wherein the program resident memory unit is a serve-based BMC (Baseboard Management Controller) module.

10. The computer program automatic recovery activation control system as recited in claim 6, which is realized as a computer program and integrated to the program resident memory unit.
